(19) United States
(12) Patent Application Publication
(10) Pub. No.: US 2026/0011484 A1
(43) Pub. Date: Jan. 8, 2026

(54) INDUCTOR AND METHOD FOR MANUFACTURING INDUCTOR

(71) Applicant: Panasonic Intellectual Property Management Co., Ltd., Osaka (JP)

(72) Inventors: Mutsuyasu OTSUBO, Hyogo (JP); Ryotaro TSUGAWA, Hyogo (JP); Naoya HONDA, Osaka (JP)

(73) Assignee: Panasonic Intellectual Property Management Co., Ltd., Osaka (JP)

(21) Appl. No.: 18/869,477

(22) PCT Filed: May 31, 2023
(86) PCT No.: PCT/JP2023/020252

§ 371 Date: Aug. 25, 2025

(30) Foreign Application Priority Data
Jun. 29, 2022 (JP) 2022-104916

(51) Int. Cl. H01F 27/28; H01F 41/10

(52) U.S. Cl. CPC H01F 27/2828; H01F 41/10

(57) ABSTRACT

An inductor includes a magnetic core and a coil element including a flat wire. The coil element includes a wound coil and a first pull-out portion connected to the coil and one (first end portion) of two end portions of the flat wire. The first pull-out portion includes two or more bent portions each having a valley on a surface of the flat wire. One of the bent portions that is located closest to the coil has, in the valley, a notch structure that is dented toward inside of the flat wire. The notch structure is dented in a direction whose angle is greater than 45 degrees, and has a deeper dent depth on one end side of the valley closer to a winding axis of the coil when compared to a dent depth on another end side of the valley far from the winding axis of the coil.

### TECHNICAL FIELD

The present disclosure relates to an inductor and a method for manufacturing an inductor.

### BACKGROUND ART

An inductor that is a passive element that stores electric energy as magnetic energy is used in, for example, a DC-DC converter device or the like for the purpose of smoothing step-up/step-down power supply voltage and DC current. The inductor is mounted, for example, on a surface of a circuit board or the like. For example, Patent Literature (PTL) 1 discloses an inductor that includes: a main body portion that contains a magnetic material; a coil element provided in the main body portion; and terminal metal fittings connected to the coil element. In the inductor disclosed in PTL 1, the leading ends of the coil element are exposed from the main body portion, and the terminal metal fittings are welded to the exposed leading ends of the coil element, respectively.

### CITATION LIST

### Patent Literature

### [PTL 1]

Japanese Unexamined Patent Application Publication No. 2011-243685

### SUMMARY OF INVENTION

### Technical Problem

There is an inductor whose coil element is formed using a flat wire that has a rectangular cross section. In the coil element formed using a flat wire, different portions of the wire may be positioned close to each other during bending processing for forming the coil element, which may reduce the insulation properties between these portions. Accordingly, there is a problem of reducing the reliability of the inductor. In view of the above, it is an object of the present disclosure to enhance the reliability of the inductor.

### Solution to Problem

An inductor according to an aspect of the present disclosure includes: a magnetic core including a first surface and a second surface connected to the first surface, the magnetic core being provided by pressure molding a mixture of a magnetic material powder and a binder; and a coil element including: an embedded portion embedded in the magnetic core; and two end portions that are connected to the embedded portion and protrude outside of the magnetic core at positions at an equal height from the first surface, the coil element being provided using a flat wire that has a rectangular cross section and includes an insulation coating on a surface of the flat wire. The embedded portion of the coil element includes: a coil provided by winding the flat wire; a first pull-out portion connected to the coil and one of the two end portions; and a second pull-out portion connected to the coil and another one of the two end portions. The first pull-out portion includes two or more bent portions that are bent in an extension direction of the flat wire, each of the two or more bent portions having a valley in the surface of the flat wire. One of the two or more bent portions that is located closest to the coil has, in the valley, a notch structure that is dented toward inside of the flat wire. In the notch structure, when viewed from an extension direction of the valley of the one of the two or more bent portions that is located closest to the coil, the notch structure is dented in a direction whose angle is greater than 45 degrees when the extension direction of the flat wire on a coil side relative to the one of the two or more bent portions is set to 0 degrees, and the valley has a deeper dent depth on one end side where a linear distance from a winding axis of the coil is short when compared to a dent depth on another end side where the linear distance from the winding axis of the coil is long.

Also, a method for manufacturing an inductor according to an aspect of the present disclosure includes: forming a coil element including a flat wire that has a rectangular cross section and includes an insulation coating on a surface of the flat wire, the forming of the coil element including: forming a coil by winding a portion of the flat wire between two end portions of the flat wire; and forming two or more bent portions, each having a valley in the surface of the flat wire, by bending a first pull-out portion two or more times, the first pull-out portion being a portion that connects one end portion, which is one of the two end portions, and the coil; and forming a magnetic core by pressure molding a mixture of a magnetic material powder and a binder to embed the coil and the first pull-out portion of the coil element into the magnetic core. The forming of the two or more bent portions includes forming a notch by denting the surface of the flat wire toward inside of the flat wire at a position corresponding to the valley of one of the two or more bent portions that is located closest to the coil, and subsequently bending the flat wire to form, in the valley, a notch structure that is dented toward the inside of the flat wire. In the notch structure, when viewed from an extension direction of the valley of the one of the two or more bent portions that is located closest to the coil, the notch structure is dented in a direction whose angle is greater than 45 degrees when the extension direction of the flat wire on a coil side relative to the one of the two or more bent portions is set to 0 degrees, and the valley has a deeper dent depth on one end side where a linear distance from a winding axis of the coil is short when compared to a dent depth on another end side where the linear distance from the winding axis of the coil is long.

### Advantageous Effects of Invention

According to the present disclosure, the reliability of the inductor can be enhanced.

### BRIEF DESCRIPTION OF DRAWINGS

FIG. 1 is a first perspective view of an inductor according to an embodiment.

FIG. 2 is a second perspective view of the inductor according to the embodiment.

FIG. 3 is a third perspective view of the inductor according to the embodiment.

FIG. 4 is a plan view of the inductor according to the embodiment.

FIG. 5 is a flowchart illustrating a method for manufacturing an inductor according to an embodiment.

FIG. 6 is a flowchart illustrating a method for forming a coil element included in the inductor according to the embodiment.

FIG. 7 is a plan view provided to illustrate a notch shape according to the embodiment.

### DESCRIPTION OF EMBODIMENT

### Circumstances Leading to the Present Disclosure

As described in the background art section above, with an inductor whose coil element is formed by bending a flat wire, it is often the case that different portions of the wire are positioned close to each other. Specifically, an example will be described assuming that, as the coil element formed using a flat wire, a coil element that includes a coil provided by winding a flat wire edgewise. Normally, when an edgewise coil is formed, two opposing end portions extending from the coil are positioned at different heights (the positions of the end portions in the winding axis direction of the coil varies) according to the number of windings. In order to embed the coil element whose opposing end portions are positioned at different heights directly into a magnetic core, it is necessary to design the magnetic core to cope with each of the end portions that are positioned at different heights.

On the other hand, from the viewpoint of inductor performance, an inductor is required to contain a magnetic material powder at a high density. Accordingly, as the magnetic compact core of the inductor, the use of a magnetic compact core formed by pressure molding a mixture of a magnetic material powder and a binder is required in some cases.

In pressure molding, it is difficult to design a magnetic core to cope with each of the end portions that are positioned at different heights because it is difficult to control the positions of the end portions before and after compression. To address this, a method may be used in which the wire is bent at pull-out portions that extend from the coil to the end portions of the coil in the magnetic core such that the heights of the end portions are level (such that the end portions are positioned at the same height). However, when the wire is bent, the metal material of the wire contracts, which may cause, on the valley side of the bent portion, the metal material to expand and extend to an outer position from the original surface position of the wire.

Particularly when the wire extending from the coil to the outside of the magnetic core, or in other words, in a direction away from the coil is bent in the winding axis direction of the coil, the side on which the metal material of the wire expands faces toward the coil, and thus the coil and the expanded wire may come close to each other.

When bending the wire, a piece of metal that has a bent corner or the like is placed against a position at which a valley is to be formed when the wire is bent, and then subjected to processing. However, due to the stress applied at this time, the insulation coating that is made of enamel or the like and covers the surface of the wire may be damaged such as being torn or detached. In addition, as described above, the wire expands, and thus the damage of the insulation coating may extend to the expanded portion to significantly reduce the insulation performance of the expanded portion.

For the reason described above, the insulation properties may be reduced between different portions of the wire, for example, the expanded portion of the wire and the coil. To address this, it is an object of the present disclosure to provide a highly reliable inductor by, before bending the wire, subjecting the wire to processing for controlling expansion of the wire caused by contraction of the metal material, and then bending the wire to suppress the occurrence of a situation in which different portions of the wire are positioned close to each other.

The present disclosure has the following configuration in order to enhance the reliability of the inductor. Hereinafter, an embodiment will be described more specifically with reference to the drawings.

The embodiment described below shows a specific example of the present disclosure. Accordingly, the numerical values, shapes, materials, structural elements, the arrangement and connection of the structural elements, steps, the order of the steps, and the like shown in the following embodiment are merely examples, and therefore are not intended to limit the scope of the present disclosure. Also, among the structural elements described in the following embodiment, structural elements not recited in any one of the independent claims are described as arbitrary structural elements.

Also, in the specification of the present application, the terms that describe the relationship between elements such as “parallel”, the terms that describe the shape of an element such as “rectangular parallelepiped”, and numerical value ranges are expressions that not only have a strict meaning but also encompass a substantially equal range, for example, a margin of about several percent.

Also, the diagrams are schematic representations in which emphasis, omission, and scaling adjustment are applied as appropriate to clearly show the present disclosure, and thus are not necessarily true to scale. Accordingly, the shape, the positional relationship, and the scale may be different from the actual shape, the actual positional relationship, and the actual scale. Also, in the diagrams, structural elements that are substantially the same are given the same reference numerals, and a redundant description may be omitted or simplified.

Also, in the diagrams, three directions that are orthogonal to each other such as the X axis, the Y axis, and the Z axis may be shown where necessary to describe these axes and axis directions that extend along these axes. Note that the axes are shown to describe the present disclosure, and thus are not intended to limit the direction and the orientation of the inductor when it is used.

Also, in the specification of the present application, the terms that describe the configuration of the inductor such as “top surface” and “bottom surface” are not necessarily used to indicate top surface (vertically upper surface) and bottom surface (vertically lower surface) recognized in an absolute space, and are also used to define a relative positional relationship between structural elements of the inductor.

### EMBODIMENT

### Configuration of Inductor

A configuration of an inductor according to an embodiment will be described. The inductor is a passive element that stores electric energy flowing through a coil element as magnetic energy.

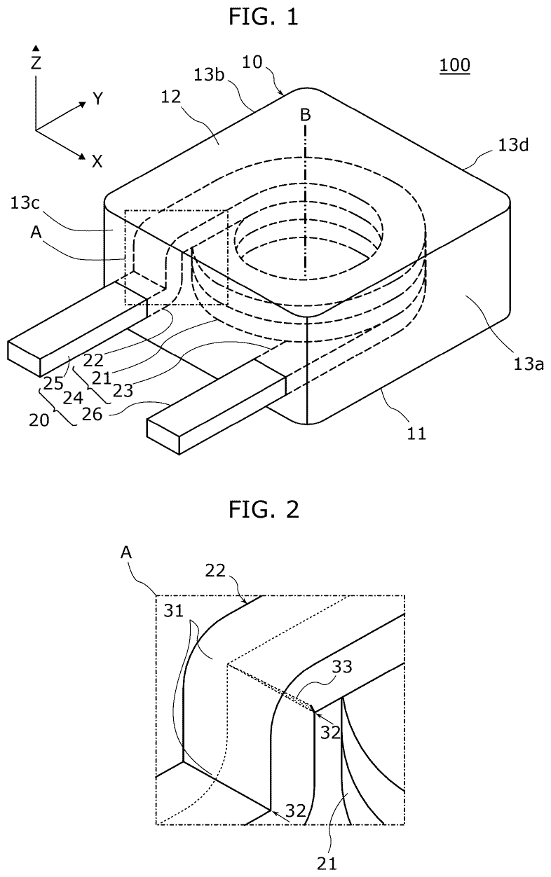

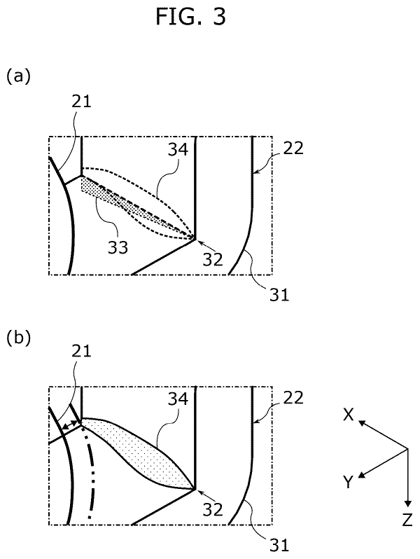

FIG. 1 is a first perspective view of an inductor according to an embodiment. FIG. 2 is a second perspective view of the inductor. Here, FIG. 2 is an enlarged perspective view of bent portion 31 shown in region A in FIG. 1.

As shown in FIGS. 1 and 2, inductor 100 includes magnetic core 10 and coil element 20 that includes coil 21 and a plurality of pull-out portions.

The approximate outer shape of inductor 100 is determined by, for example, the shape of magnetic core 10 that is a rectangular parallelepiped shaped magnetic compact core. Magnetic core 10 can be formed in any shape through molding. That is, inductor 100 of a desired shape can be obtained by controlling the shape of magnetic core 10 during molding. Magnetic core 10 according to the present embodiment has, for example, a dimension in the X axis direction of 17 mm or more and 70 mm or less, a dimension in the Y axis direction of 17 mm or more and 70 mm or less, and a dimension in the Z axis direction of 7 mm or more and 50 mm or less. For example, magnetic core 10 has a dimension in the X axis direction of 40 mm, a dimension in the Y axis direction of 40 mm or more, and a dimension in the Z axis direction of 18 mm.

Magnetic core 10 is an outer shell portion of inductor 100, and covers a portion (embedded portion 24 that includes coil 21, first pull-out portion 22, and second pull-out portion 23) of coil element 20. In other words, embedded portion 24 is embedded in magnetic core 10. Magnetic core 10 is a magnetic compact core that contains a magnetic material, and is formed using, for example, a metal magnetic material powder, a resin material for binding particles of the magnetic material powder as a binder, and the like. It is sufficient that magnetic core 10 is formed using a magnetic material. As the magnetic material, ferrite may be used, or any other magnetic material may be used. As the metal magnetic material powder, a particulate material that has a predetermined elemental composition such as an Fe—Si—Al-based material powder, an Fe—Si-based material powder, an Fe—Si—Cr-based material powder, or an Fe—Si—Cr—B-based material powder is used. As the resin material, a material that can bind particles of the metal magnetic material powder while providing insulation between particles of the metal magnetic material powder, and can thereby retain a predetermined shape such as a silicone-based resin is selected.

Magnetic core 10 has, for example, a rectangular parallelepiped shape. Magnetic core 10 includes bottom surface (in other words, first surface) 11, top surface 12 that faces toward bottom surface 11, and four side surfaces 13a, 13b, 13c, and 13d (in other words, end surfaces) that are connected to bottom surface 11 and top surface 12. In this example, an example will be described in which, out of side surfaces 13a, 13b, 13c, and 13d, side surface 13c is a second surface, and side surfaces 13a, 13b, and 13d are third surfaces. Note that any one of side surfaces 13a, 13b, 13c, and 13d may be a second surface. Side surface 13a and side surface 13b are aligned in the X axis direction and face toward each other. Side surface 13c and side surface 13d are aligned in the Y axis direction and face toward each other. Bottom surface 11, top surface 12, and side surfaces 13a, 13b, 13c, and 13d are substantially flat surfaces. A pair of bottom surface 11 and top surface 12, a pair of side surface 13a and side surface 13b, and a pair of side surface 13c and side surface 13d are in a substantially parallel relationship to each other. Bottom surface 11 and top surface 12 extend in a direction that intersects side surfaces 13a, 13b, 13c, and 13d, specifically, in a direction perpendicular to side surfaces 13a, 13b, 13c, and 13d. Also, side surface 13a and side surface 13b extend in a direction that intersects side surfaces 13c and 13d, specifically, in a direction perpendicular to side surfaces 13c and 13d.

Coil element 20 is formed using one wire embedded in magnetic core 10, and includes coil 21 that is a wound portion formed by winding the wire, a plurality of end portions that correspond to opposing ends of the wire and are exposed to the outside of magnetic core 10, and pull-out portions that connect the end portions and coil 21. That is, coil element 20 according to the embodiment is composed of one coil 21, two pull-out portions, and two end portions. In FIG. 1, coil 21 and the pull-out portions embedded in magnetic core 10 are indicated by a broken line.

Coil element 20 is formed using, for example, a conductor wire. The conductor wire includes a metal wire and an insulation coating that covers a surface of the metal wire. The metal wire is made of a metal material selected from, for example, metals such as aluminum, copper, silver, and gold, alloys that contain one or more of these metals, materials composed of any of the metals or the alloys and other substance, and the like. Specifically, the conductor wire is, for example, a copper wire covered with an insulation coating. Here, the terms “coil 21”, “pull-out portion”, and “end portion” refer to, for example, different portions of a formed body obtained by processing one member made of the same material.

Coil 21 is a portion of embedded portion 24 covered with magnetic core 10. Coil 21 is formed of a wound conductor wire and functions as a coil. There is no particular limitation on the number of windings of coil 21. The number of windings of coil 21 is selected as appropriate according to constraints such as the performance required for inductor 100 and the size of magnetic core 10, and may be, for example, 0.5 turns to 10 turns. The conductor wire that constitutes coil 21 is a flat wire whose cross section has, for example, a size of 6.0 mm×3.5 mm. Coil 21 may be formed using a square wire whose cross section has an aspect ratio of 1:1. Coil 21 is formed as a result of a conductor wire being vertically wound such that the surfaces of the wire including the long sides of the cross section of the wire are stacked. That is, coil 21 is formed by winding a flat wire edgewise. Coil 21 is embedded in magnetic core 10 such that winding axis B (indicated by a dashed-double dotted line in FIG. 1) of coil 21 extends in a direction (the Z axis direction) that connects bottom surface 11 and top surface 12.

Coil 21 includes first pull-out portion 22 and second pull-out portion 23 that are connected to side surface 13c of magnetic core 10 from the wound portion. Hereinafter, first pull-out portion 22 and second pull-out portion 23 may be referred to collectively as “pull-out portion” unless otherwise necessary to distinguish them. The pull-out portions are provided such that, when viewed from a direction perpendicular to side surface 13c, second pull-out portion 23 is on the plus side of the X axis, which is the outer right side relative to winding axis B, and first pull-out portion 22 is on the minus side of the X axis, which is the outer left side relative to winding axis B. Also, second pull-out portion 23 is located at a height closer to bottom surface 11 rather than the center of side surface 13c when viewed from the direction perpendicular to side surface 13c. On the other hand, first pull-out portion 22 extends in the direction that connects bottom surface 11 and top surface 12 from a height closer to top surface 12 rather than the center of side surface 13c to a position at the same height as second pull-out portion 23 when viewed from the direction perpendicular to side surface 13c. On side surface 13c, the pull-out portions are located at positions at the same height from bottom surface 11. In other words, on side surface 13c, the pull-out portions are located at positions at the same distance from bottom surface 11.

The end portions are connected to coil 21 via the pull-out portions. The end portions include first end portion 25 and second end portion 26. First end portion 25 is connected to coil 21 via first pull-out portion 22. Second end portion 26 is connected to coil 21 via second pull-out portion 23. Hereinafter, first end portion 25 and second end portion 26 may be referred to collectively as “end portion” unless otherwise necessary to distinguish them. The end portions are pulled out from side surface 13c of magnetic core 10 to extend to the outside of magnetic core 10. Specifically, the end portions are pulled out in a direction perpendicular to side surface 13c from a height closer to bottom surface 11 rather than the center of side surface 13c. The end portions are pulled out from one side surface 13c, which is one of four side surfaces 13a to 13d. In other words, the two end portions protrude to the outside of magnetic core 10 on the same side surface, which is one of four side surfaces 13a to 13d.

In FIG. 2, the configuration on the opposite side from the viewpoint side is shown by a broken line in a see-through manner. As shown in FIG. 2, first pull-out portion 22 includes bent portion 31 at which the wire is bent in a wire extension direction at a position between a section extending in a direction away from coil 21 and a section extending along winding axis B of coil 21 or the direction that connects bottom surface 11 and top surface 12. Likewise, first pull-out portion 22 also includes another bent portion 31 at which the wire is bent in the wire extension direction at a position between the section extending along winding axis B of coil 21 and a section extending in the direction away from coil 21 at a height parallel to the height of second pull-out portion 23.

As a result of bent portion 31 being provided, in the flat wire used as the wire, valley 32 that extends along a direction perpendicular to both the wire extension direction before bent portion 31 and the wire extension direction after bent portion 31 is formed. Valley 32 can be interpreted as a fold formed on the inner side of the bend. In the present embodiment, inductor 100 will be described in which first pull-out portion 22 includes two bent portions 31. However, first pull-out portion 22 may include three or more bent portions 31. Also, the second pull-out portion may also include a plurality of bent portions. In the present embodiment, inductor 100 will be described in which the pull-out portions are located at positions at a height closer to bottom surface 11 rather than the center of side surface 13c. However, the pull-out portions are only required to be located at positions at the same height on side surface 13c, and thus the pull-out portions may be located at positions at a center in the height of side surface 13c or closer to top surface 12 rather than the center of side surface 13c.

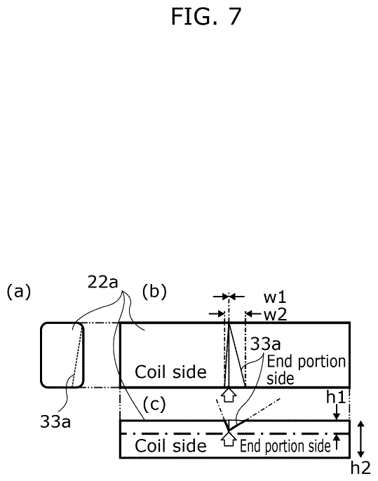

In the present embodiment, in the wire, one of two bent portions 31 that is located closest to coil 21, or in other words, one of two bent portions 31 that has the shortest linear distance between valley 32 and coil 21 has a configuration different from the configuration of another one of two bent portions 31. Specifically, bent portion 31 closest to coil 21 has, at the position of valley 32, notch structure 33 (an area hatched with dots in FIG. 1) where the surface of the wire is dented toward the inside of the wire. Notch structure 33 has a planar shape in which a space present before the wire is bent is filled after the wire has been bent and that has a depth within a plane that intersects the surface of the wire. Accordingly, in the wire before bending, notch 33a (see FIG. 7, which will be described later) for forming notch structure 33 is formed. Notch 33a will be described later when describing FIG. 7.

Due to the presence of notch 33a, an expanded portion of the metal material from the surface of the wire formed by contraction of the metal material on the inside of the bend relative to the neutral line when the wire is bent can be pushed into the space of notch 33a, and thus the expanded portion can be kept relatively small. As a result, in bent portion 31 of first pull-out portion 22, the expanded portion that expands toward coil 21 is unlikely to be large, and thus the distance between coil 21 and the expanded portion of first pull-out portion 22 can be easily maintained.

A more specific description will be given with reference to FIG. 3. FIG. 3 is a third perspective view of the inductor according to the embodiment. FIG. 3 is a perspective view showing the periphery of bent portion 31 closest to coil 21, as viewed from a viewpoint different from FIG. 2. In (a) in FIG. 3, the outline of expanded portion 34 is shown by a broken line, and notch structure 33 is also shown by a different broken line in a see-through manner. In (b) in FIG. 3, expanded portion 34 is shown in a non-see-through manner.

As shown in FIG. 3, in notch structure 33, the dent depth into the wire varies depending on the position in an extension direction of valley 32. The dent depth of the notch structure is proportional to the size of space of notch 33a before the wire is bent. Accordingly, the larger the space, the deeper the dent depth. As shown in (a) in FIG. 3, the dent depth is deepest on one end side of valley 32 that has a shorter linear distance from coil 21, or in other words, on one end side (on the plus side of the X axis) of valley 32 that has a shorter linear distance from winding axis B of coil 21, and is shallowest on another end side (on the minus side of the X axis).

With the configuration described above, as indicated by a bidirectional arrow in (b) in FIG. 3, it is possible to suppress a reduction of the cross-sectional area, or in other words, an increase in resistance caused by making notch structure 33 too large while suppressing an increase in the size of expanded portion 34 that is located at a shorter linear distance from coil 21 and has a higher risk of reduction of insulation properties. Notch structure 33 may have a dent depth of 0 at one end and another end of valley 32. That is, the space of notch 33a may be formed only in a portion of valley 32 in the extension direction of valley 32.

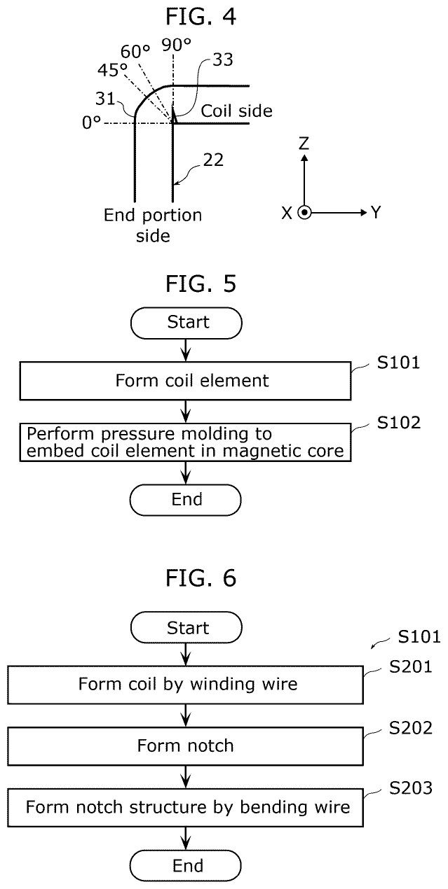

FIG. 4 is a plan view of the inductor according to the embodiment. In FIG. 4, a plan view of bent portion 31 closest to coil 21 in first pull-out portion 22 as viewed from coil 21 side (on the plus side of the X axis) along which the extension direction of valley 32 extends is shown. As shown in FIG. 4, notch structure 33 of the present embodiment is dented in a direction whose angle is greater than 45 degrees, to be more specific, within a range of 60 degrees or more and 90 degrees or less, when the extension direction of the wire on coil 21 side relative to bent portion 31 is set to 0 degrees. This configuration correlates with characteristics associated with the configuration of notch 33a for forming notch structure 33, and thus will be described later when describing notch 33a.

### Method for Manufacturing Inductor

Next, a method for manufacturing inductor 100 described above will be described. A method for manufacturing an inductor according to an embodiment is performed in the following manner. The method for manufacturing inductor 100 is not limited to the examples given below. FIG. 5 is a flowchart illustrating the method for manufacturing an inductor according to the embodiment. FIG. 6 is a flowchart illustrating a method for forming a coil element included in the inductor according to the embodiment.

In the method for manufacturing inductor 100, first, a step (S101) of forming a coil element is performed. As shown in FIG. 6, this step is divided into three substeps. Specifically, first, a portion of a wire between two end portions of the wire is wound to form coil 21 (S201). After coil 21 has been formed or before the final turns of coil 21 are formed, notch 33a is formed at a position at which valley 32 is to be formed when the wire is bent (S202). Notch 33a is formed by being pressed by a die that has a protrusion that has the same shape as the shape of the space of notch 33a. The space of notch 33a is formed by pressing the metal material corresponding to the space of notch 33a into the wire. Notch 33a may be formed using a different method such as cutting. After notch 33a has been formed, the wire is bent along notch 33a to form bent portion 31, and thereby notch structure 33 is formed (S203). If step S101 has not been completed at this time, the final turns of coil 21 are formed to finish winding.

Here, the shape of notch 33a will be described with reference to FIG. 7. FIG. 7 is a plan view provided to illustrate the shape of the notch shape according to the embodiment. In FIG. 7, (a) shows a plan view of pull-out portion 22a that corresponds to first pull-out portion 22 before the wire is bent as viewed from the wire extension direction, (b) shows a plan view of pull-out portion 22a as viewed from a direction perpendicular to both the wire extension direction and the extension direction of notch 33a (corresponding to the extension direction of valley 32), and (c) shows a plan view of pull-out portion 22a as viewed from the extension direction of notch 33a.

In (a) in FIG. 7, notch 33a is shown by a broken line in a see-through manner. As shown in FIG. 7, notch 33a is configured to absorb the expansion of expanded portion 34 when the wire is bent according to the size of the space. For this reason, notch 33a is formed such that notch 33a has a large space on one end side where the linear distance from coil 21 is shortest and it is required to more absorb the expansion of expanded portion 34, and has a small space on another end side to suppress the reduction in the cross-sectional area caused by forming notch structure 33.

For this purpose, notch 33a has a deeper dent depth on the one end side where the linear distance from coil 21 is shortest, and a shallow dent depth on another end side. For example, in notch 33a, the deepest dent depth (indicated by h1 in (c) in FIG. 7) may be 10% or more or 20% or more of the length (indicated by h2 in (c) in FIG. 7) of the flat wire in the dent direction. With this configuration, the expansion of expanded portion 34 can be effectively absorbed by the space of notch 33a. Likewise, the deepest dent depth of notch structure 33 may also be 10% or more or 20% or more of the length of the flat wire in the dent direction. However, strictly speaking, due to the contraction of the metal material, the dent depth of the notch structure and the dent depth of notch 33a are not the same, and thus the dent depth may be set in either one of notch 33a or notch structure 33. Also, strictly speaking, after the wire has been bent, the wire is thinner on the outer side than the neutral surface, and thus the proportion of the dent depth of notch structure 33 relative to the thickness of the wire before the wire is bent tends to be large.

Also, in notch 33a, deepest dent depth h1 may be 50% or less or 40% or less of length h2 of the flat wire in the dent direction. With this configuration, it is possible to prevent a reduction in the cross sectional area more than necessary caused by forming notch structure 33. Likewise, the deepest dent depth of notch structure 33 may also be 50% or less or 40% or less of the length of the flat wire in the dent direction. However, strictly speaking, due to the contraction of the metal material, the dent depth of notch structure 33 and the dent depth of notch 33a are not the same, and thus the dent depth may be set in either one of notch 33a or notch structure 33.

It is more ideal to form notch structure 33 and notch 33a between the inside (the side on which the metal material contracts) of bent portion 31 formed by bending the flat wire and the neutral surface of the flat wire. To this end, the dent depth may be determined by performing in advance an experiment or the like for estimating the neutral line of the flat wire.

Also, as shown in FIG. 7, in notch 33a, an inclination angle from the extension direction of notch 33a to the deepest position (indicated by a white arrow in the diagram) is different between coil 21 side relative to the deepest position in the wire and first end portion 25 side relative to the deepest position in the wire as viewed from the extension direction of notch 33a. Specifically, the inclination angle from the extension direction of notch 33a is steeper on coil 21 side than on first end portion 25. As a result, expanded portion 34 is more unlikely to be formed on coil 21 side than at the deepest position of the wire, and thus most of expanded portion 34 can be formed concentratedly on first end portion 25 side, or in other words, on the far side from coil 21.

The inclination angle of notch 33a is only required to be designed to form a large space on first end portion 25 side by an amount corresponding to the degree of steep on coil 21 side. The design may be determined empirically or experimentally.

Also, as shown in FIG. 7, in notch 33a, the width of notch 33a extending in a direction perpendicular to the extension direction of notch 33a is different at two opposing ends of notch 33a in the extension direction of notch 33a. Specifically, width w1 of notch 33a on another end side where the linear distance from winding axis B is long is shorter than width w2 of notch 33a on one end side where the linear distance from winding axis B is short. To put it another way, width w2 of notch 33a on one end side is longer than width w1 of notch 33a on another end side. With the configuration in which the width of notch 33a varies along the extension direction of notch 33a, a large space is likely to be formed on one end side of notch 33a than on the other end side of notch 33a. Specifically, combined with the description of the dent depth given above, notch 33a on one end side has width w2 that is longer than that on the other end side, and also has a dent depth deeper than that on the other end side, and thus a larger space is formed on one end side than on the other end side. Conversely, notch 33a on the other end side has width w1 that is shorter than that on one end side, and has a dent depth shallower than that on one end side, and thus a smaller space is formed on the other end side than on one end side.

Referring back to FIG. 5, coil element 20 formed is placed in a molding die together with a mixture of a magnetic material powder and a binder, and the magnetic compact core is pressure molded to embed coil element 20 into magnetic core 10 (S102). The compression force applied during pressure molding is, for example, 5 ton/cm², and the thermal curing temperature is, for example, 185° C. After the pressure molding, the end portions not covered with magnetic core 10 and thus exposed protrude, for example, perpendicularly to side surface 13c of magnetic core 10. The end portions are irradiated with, for example, a laser beam to remove the insulation coating. In this way, inductor 100 is manufactured.

### Advantageous Effects, etc.

First Aspect: Inductor 100 according to the present embodiment includes: magnetic core 10 including bottom surface 11 (first surface) and side surface 13c (second surface) connected to bottom surface 11, magnetic core 10 being provided by pressure molding a mixture of a magnetic material powder and a binder; and coil element 20 including embedded portion 24 embedded in magnetic core 10; and two end portions that are connected to embedded portion 24 and protrude outside of magnetic core 10 at positions at an equal height from bottom surface 11, coil element 20 being provided using a flat wire that has a rectangular cross section and includes an insulation coating on a surface of the flat wire, wherein embedded portion 24 of coil element 20 includes: coil 21 formed by winding the flat wire; first pull-out portion 22 connected to coil 21 and one (first end portion 25) of the two end portions; and second pull-out portion 23 connected to coil 21 and another one (second end portion 26) of the two end portions, first pull-out portion 22 includes two or more bent portions 31 formed by bending the flat wire in an extension direction of the flat wire, each of two or more bent portions 31 having valley 32 on the surface of the flat wire, one of two or more bent portions 31 that is located closest to coil 21 has, in valley 32, notch structure 33 that is dented toward inside of the flat wire, and in notch structure 33, when viewed from an extension direction of valley 32 of the one of two or more bent portions 31 that is located closest to coil 21, notch structure 33 is dented in a direction whose angle is greater than 45 degrees when the extension direction of the flat wire on coil 21 side relative to bent portion 31 is set to 0 degrees, and valley 32 has a deeper dent depth on one end side where a linear distance from winding axis B of coil 21 is short when compared to a dent depth on another end side where the linear distance from the linear distance from winding axis B of coil 21 is long.

With this configuration as a result of bent portion 31 being provided, expanded portion 34 formed on the valley side of the bent portion can be absorbed when notch structure 33 is formed. The dent depth of notch structure 33 corresponds to the volume of expanded portion 34 that can be absorbed when notch structure 33 is formed, and thus expanded portion 34 is more unlikely to be formed, or in other words, the size of expanded portion 34 formed can be more reduced on one end side of valley 32 than on the other end side of valley 32. At this time, notch structure 33 is dented in a direction whose angle is greater than 45 degrees when the extension direction of the flat wire on coil 21 side relative to bent portion 31 is set to 0 degrees. That is, notch structure 33 is steeper on coil 21 side relative to bent portion 31 than on first end portion 25 side relative to bent portion 31. With steep notch structure 33, a deformation caused by bending the wire is unlikely to occur, and rather, the deformation caused by bending the wire can be concentrated on first end portion 25 side relative to bent portion 31. Accordingly, expanded portion 34 is unlikely to be formed on coil 21 side relative to valley 32, and most of expanded portion 34 can be formed concentratedly on first end portion 25 side, or in other words, on the far side from coil 21. As a result, the reduction in insulation properties between one end side of valley 32 and coil 21 can be suppressed, and most of expanded portion 34 can be formed concentratedly on the far side from coil 21, which also suppresses the insulation properties between one end side of valley 32 and coil 21, and it is therefore possible to achieve highly reliable inductor 100.

Second Aspect: Inductor 100 according to the first aspect, wherein, when viewed from the extension direction of the valley of the one of the two or more bent portions that is located closest to the coil, the notch structure is dented in a direction whose angle is 60 degrees or more and 90 degrees or less when the extension direction of the flat wire on the coil side relative to the one of the two or more bent portions is set to 0 degrees.

With this configuration, the advantageous effect that expanded portion 34 is unlikely to be formed on coil 21 side relative to valley 32 can be further enhanced.

Third Aspect: Inductor 100 according to the first or second aspect, wherein magnetic core 10 further includes side surfaces 13a, 13b, and 13d (third surfaces) connected to bottom surface 11, and the two end portions protrude outside of magnetic core 10 from side surface 13c.

With this configuration, it is possible to achieve inductor 100 with two end portions of the wire protruding from side surface 13c. This configuration is advantageous in terms of ease of connection because it is easy to handle inductor 100 when inductor 100 is integrated into an electronic circuit.

Fourth Aspect: Inductor 100 according to any one of the first to the third aspects, wherein, in notch structure 33, a deepest dent depth is 10% or more of a length of the flat wire in a dent direction.

With this configuration, it is possible to achieve inductor 100 including notch structure 33 that has a dent depth necessary to further reduce the size of expanded portion 34.

Fifth Aspect: Inductor 100 according to any one of the first to fourth aspects, wherein, in notch structure 33, a deepest dent depth is 50% or less of a length of the flat wire in a dent direction.

With this configuration, it is possible to achieve inductor 100 in which the cross sectional area of the flat wire can be maintained at a certain level or more even when the cross sectional area of the flat wire is reduced by notch structure 33, and an increase in resistance can be suppressed while including notch structure 33.

Sixth Aspect: A method for manufacturing inductor 100 according to the present embodiment includes: forming coil element 20 using a flat wire that has a rectangular cross section and includes an insulation coating on a surface of the flat wire, the forming of coil element 20 including: forming coil 21 by winding a portion of the flat wire between two end portions of the flat wire; and forming two or more bent portions 31, each of two or more bent portions 31 having valley 32 on the surface of the flat wire, by bending first pull-out portion 22 two or more times, first pull-out portion 22 being a portion that connects one end portion (first end portion 25), which is one of the two end portions, and coil 21; and forming magnetic core 10 by pressure molding a mixture of a magnetic material powder and a binder to embed coil 21 and first pull-out portion 22 of coil element 20 into magnetic core 10, wherein the forming of two or more bent portions 31 includes forming notch 33a by denting the surface of the flat wire toward inside of the flat wire at a position corresponding to valley 32 of one of two or more bent portions 31 that is located closest to coil 21, and subsequently bending the flat wire to form, in valley 32, notch structure 33 is dented toward the inside of the flat wire, and in notch structure 33, when viewed from an extension direction of valley 32 of the one of two or more bent portions 31 that is located closest to coil 21, notch structure 33 is dented in a direction whose angle is greater than 45 degrees when the extension direction of the flat wire on coil 21 side relative to bent portion 31 is set to 0 degrees, and valley 32 has a deeper dent depth on one end side where a linear distance from winding axis B of coil 21 is short when compared to a dent depth on another end side where the linear distance from the linear distance from winding axis B of coil 21 is long.

Seventh Aspect: The method for manufacturing inductor 100 according to the sixth aspect, wherein, in the notch, when viewed from an extension direction of the valley, when viewed from the extension direction of the valley, an inclination angle extending to a position at which the dent depth is deepest is different between the coil side relative to the position at which the dent depth is deepest and on the one end portion side relative to the position at which the dent depth is deepest.

Eighth Aspect: The method for manufacturing inductor 100 according to the seventh aspect, wherein, in the notch, when viewed from the extension direction of the valley, the inclination angle extending to the position at which the dent depth is deepest is steeper on the coil side relative to the position at which the dent depth is deepest than on the one end portion side relative to the position at which the dent depth is deepest.

According to any of the aspects given above, it is possible to manufacture inductor 100 according to the first aspect and the like.

### Other Embodiments, etc.

The inductors and the like according to the embodiment and the variations of the present disclosure have been described above. However, the scope of the present disclosure is not limited to the embodiment and the variations given above. Other embodiments obtained by making various modifications that can be conceived by a person having ordinary skill in the art to the embodiment and the variations as well as embodiments constructed by combining some of the structural elements of the embodiment and the variations without departing from the spirit of the present disclosure are also encompassed within the scope of the present disclosure.

For example, in the embodiment given above, an example was shown in which the end portions of the wire are pulled out from a height closer to bottom surface 11 rather than the center of side surface 13c. However, the configuration is not limited thereto. The pull-out portions may be pulled out from a height closer to top surface 12 rather than the center of side surface 13c. In this case, in second pull-out portion 23, bent portion 31 configured as described above can be formed.

Also, for example, terminal metal fittings (not shown) may be welded and connected to the ends of first end portion 25 and second end portion 26, respectively. Alternatively, the ends of first end portion 25 and second end portion 26 may be bent to form surface mount electrodes.

Also, for example, electric products and electric circuits produced using the above-described inductor are also encompassed in the scope of the present disclosure. Examples of the electric products include a power supply device that includes the above-described inductor, various types of equipment that includes the power supply device, and the like.

### INDUSTRIAL APPLICABILITY

The inductor according to the present disclosure is useful as an inductor used in various types of devices and equipment, and the like.

### REFERENCE SIGNS LIST

10 magnetic core
11 bottom surface (first surface)
12 top surface
13a, 13b, 13c, 13d side surface
20 coil element
21 coil
22 first pull-out portion
22a pull-out portion
23 second pull-out portion
24 embedded portion
25 first end portion
26 second end portion
31 bent portion
32 valley
33 notch structure
33a notch
34 expanded portion
100 inductor

1. An inductor comprising:
a magnetic core including a first surface and a second surface connected to the first surface, the magnetic core being provided by pressure molding a mixture of a magnetic material powder and a binder; and
a coil element including: an embedded portion embedded in the magnetic core; and two end portions that are connected to the embedded portion and protrude outside of the magnetic core at positions at an equal height from the first surface, the coil element being provided using a flat wire that has a rectangular cross section and includes an insulation coating on a surface of the flat wire,
wherein the embedded portion of the coil element includes: a coil provided by winding the flat wire; a first pull-out portion connected to the coil and one of the two end portions; and a second pull-out portion connected to the coil and another one of the two end portions,
the first pull-out portion includes two or more bent portions that are bent in an extension direction of the flat wire, each of the two or more bent portions having a valley in the surface of the flat wire,
one of the two or more bent portions that is located closest to the coil has, in the valley, a notch structure that is dented toward inside of the flat wire, and
in the notch structure,
when viewed from an extension direction of the valley of the one of the two or more bent portions that is located closest to the coil, the notch structure is dented in a direction whose angle is greater than 45 degrees when the extension direction of the flat wire on a coil side relative to the one of the two or more bent portions is set to 0 degrees, and
the valley has a deeper dent depth on one end side where a linear distance from a winding axis of the coil is short when compared to a dent depth on another end side where the linear distance from the winding axis of the coil is long.

2. The inductor according to claim 1,
wherein, when viewed from the extension direction of the valley of the one of the two or more bent portions that is located closest to the coil, the notch structure is dented in a direction whose angle is 60 degrees or more and 90 degrees or less when the extension direction of the flat wire on the coil side relative to the one of the two or more bent portions is set to 0 degrees.

3. The inductor according to claim 1,
wherein the magnetic core further includes third surfaces connected to the first surface, and
the two end portions protrude outside of the magnetic core from the second surface.

4. The inductor according to claim 1,
wherein, in the notch structure, a deepest dent depth is 10% or more of a length of the flat wire in a dent direction.

5. The inductor according to claim 1,
wherein, in the notch structure, a deepest dent depth is 50% or less of a length of the flat wire in a dent direction.

6. A method for manufacturing an inductor, the method comprising:
forming a coil element including a flat wire that has a rectangular cross section and includes an insulation coating on a surface of the flat wire, the forming of the coil element including: forming a coil by winding a portion of the flat wire between two end portions of the flat wire; and forming two or more bent portions, each having a valley in the surface of the flat wire, by bending a first pull-out portion two or more times, the first pull-out portion being a portion that connects one end portion, which is one of the two end portions, and the coil; and
forming a magnetic core by pressure molding a mixture of a magnetic material powder and a binder to embed the coil and the first pull-out portion of the coil element into the magnetic core,
wherein the forming of the two or more bent portions includes forming a notch by denting the surface of the flat wire toward inside of the flat wire at a position corresponding to the valley of one of the two or more bent portions that is located closest to the coil, and subsequently bending the flat wire to form, in the valley, a notch structure that is dented toward the inside of the flat wire, and
in the notch structure,
when viewed from an extension direction of the valley of the one of the two or more bent portions that is located closest to the coil, the notch structure is dented in a direction whose angle is greater than 45 degrees when the extension direction of the flat wire on a coil side relative to the one of the two or more bent portions is set to 0 degrees; and
the valley has a deeper dent depth on one end side where a linear distance from a winding axis of the coil is short when compared to a dent depth on another end side where the linear distance from the winding axis of the coil is long.

7. The method for manufacturing the inductor according to claim 6,
wherein, in the notch, when viewed from the extension direction of the valley, an inclination angle extending to a position at which the dent depth is deepest is different between the coil side relative to the position at which the dent depth is deepest and on the one end portion side relative to the position at which the dent depth is deepest.

8. The method for manufacturing the inductor according to claim 7,
wherein, in the notch, when viewed from the extension direction of the valley, the inclination angle extending to the position at which the dent depth is deepest is steeper on the coil side relative to the position at which the dent depth is deepest than on the one end portion side relative to the position at which the dent depth is deepest.
